(19) United States
(12) Patent Application Publication
(10) Pub. No.: US 2002/0183230 A1
(43) Pub. Date: Dec. 5, 2002

(54) Enzymatic liquid cleaning composition exhibiting enhanced alpha-amylase enzyme stability

(75) Inventors: Brian Xiaoqing Song, West Chester, OH (US); Kenton Ray Lynde, Gosforth (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/122,855

(22) Filed: Apr. 15, 2002

Related U.S. Application Data
(63) Continuation-in-part of application No. PCT/US00/28559, filed on Oct. 13, 2000.
(60) Provisional application No. 60/159,858, filed on Oct. 15, 1999.

(51) Int. Cl. C11D 3/00; C12S 9/00

(52) U.S. Cl. 510/392; 510/403; 510/505

(57) ABSTRACT

An aqueous liquid or gel type detergent composition comprises (a) from about 0.1% to about 15% by weight, boric acid; (b) from about 0.1% to about 10% by weight, a polyhydroxy compound selected from the group consisting of ethylene glycol, propylene glycol, 1,2-propanediol, butylene glycol, hexylene glycol, mannitol, sorbitol, erythritol, glucose fructose, lactose, erythritol-1,4-anhydride, and mixtures thereof; and (c) an oxygen bleach resistant α-amylase enzyme and (d) from about 5% to about 80% water.

### CROSS-REFERENCE

This is a continuation of International Application PCT/US0028559, filed Oct. 13, 2000, which claims the benefit of U.S. Provisional Application 60/159,858, filed Oct. 15, 1999.

### TECHNICAL FIELD

The present invention relates to aqueous liquid or gel type detergent compositions. More particularly, the invention relates to aqueous liquid or gel type detergent compositions exhibiting enhanced α-amylase enzyme stability by using a combination of an oxygen bleach resistant α-amylase enzyme, boric acid and propanediol, even with the exclusion of alkali metal sulfites, and a process of enhancing stability of α-amylase enzyme in an liquid dishwashing detergent.

### BACKGROUND OF THE INVENTION

Aqueous liquid enzymatic detergent compositions are well-known in the art. The major problem encountered with such compositions is that of ensuring a sufficient storage stability of the enzymes in these compositions.

It is desirable to enhance the stability of amylase enzymes in aqueous liquid or gel type detergent compositions. High-alkaline amylases, such as alpha amylases are described in British Specification No. 1-296839, assigned to Novo, incorporated herein by reference. The use of an enzyme stabilizing system, comprising a mixture of boric acid or an alkalimetalborate with a polyol or a polyfunctional amino compound, together with a certain level of a reducing alkalimetal salt such as sodium sulphite, is known and disclosed in U.S. Pat. No. 4,462,922, incorporated herein by reference.

However it has been desirable to attain enzyme stability of amylase enzymes without resorting to the use of alkalimetal sulfites in combination with boric acid and polyhydroxy compounds. It has also been desirable to be able to use boric acid rather than alkalimetal borates and still obtain a high degree of enzyme stability. It has been desirable to have an alkalimetal sulphite free system which includes the use of a specific type of an amylase enzyme which is stable to oxygen bleach and degradation, as compared to Termamyl. It has been desirable to use low levels of boric acid, propanediol and low to zero level alkali metal sulphites because lower levels of these components helps improve the transluscency and transparency of the composition. However, in the past it has been understood that low levels of one or more of the aforementioned boric acid, diol and alkali metal sulphites cause enzyme degradation. The present invention utilizes low levels of the aforementioned components in combination while surprisingly enhancing enzyme stability.

The present invention is thus directed to overcome one or more of the problems as set forth before.

### BACKGROUND ART

U.S. Pat. No. 4,462,922, issued to Boskamp, Jelles V., and assigned to Lever Brothers Company, discloses an enzyme stabilizing system, comprising a mixture of boric acid or an alkalimetalborate with a polyol or a polyfunctional amino compound, together with a certain level of a reducing alkalimetal salt such as sodium sulphite.

U.S. Pat. No. 4,404,115, issued to Tai, Ho T., and assigned to Lever Brothers Company, discloses an enzymatic liquid cleaning composition, comprising an enzyme stabilizing system including an alkalimetal borate, alkalimetal sulphite and a polyol.

### SUMMARY OF THE INVENTION

The invention meets the needs above by providing an aqueous liquid or gel type detergent composition, and a process for stabilizing an amylase enzyme in an aqueous enzymatic liquid detergent composition.

In one aspect of the present invention, an aqueous liquid or gel type detergent composition comprises (a) from about 0.1% to about 15% by weight, boric acid; (b) from about 0.1% to about 10% by weight, a polyhydroxy compound selected from the group consisting of ethylene glycol, propylene glycol, 1,2-propanediol, butylene glycol, hexylene glycol, mannitol, sorbitol, erythritol, glucose fructose, lactose, erythritol-1,4-anhydride, and mixtures thereof; and (c) an oxygen bleach resistant α-amylase enzyme and (d) from about 5% to about 80% water.

In another aspect of the present invention, a process for stabilizing an amylase enzyme in an aqueous enzymatic liquid detergent composition comprises the steps of providing an enzyme stabilizing combination comprising (a) from about 0.1% to about 15% by weight, boric acid; (b) from about 0.1% to about 10% by weight, a polyhydroxy compound selected from the group consisting of ethylene glycol, propylene glycol, 1,2-propanediol, butylene glycol, hexylene glycol, mannitol, sorbitol, erythritol, glucose fructose, lactose, erythritol-1,4-anhydride, and mixtures thereof; and (c) an oxygen bleach resistant α-amylase enzyme. The process also includes the step of mixing the enzyme stabilizing combination with liquid detergent ingredients.

### DETAILED DESCRIPTION OF THE INVENTION

In the preferred embodiment of the present invention, an aqueous liquid or gel type detergent composition comprises (a) from about 0.1% to about 15% by weight, boric acid; (b) from about 0.1% to about 10% by weight, a polyhydroxy compound selected from the group consisting of ethylene glycol, propylene glycol, 1,2-propanediol, butylene glycol, hexylene glycol, mannitol, sorbitol, erythritol, glucose fructose, lactose, erythritol-1,4-anhydride, and mixtures thereof; and (c) an oxygen bleach resistant α-amylase enzyme and (d) from about 5% to about 80% water.

In the preferred embodiment, the boric acid is desirably present in an amount from about 0.5% to about 10% by weight, and preferably from about 1% to about 5%. The polyhydroxy compound is preferably 1,2-propanediol. In the preferred embodiment, the polyhydroxy compound is desirably present in an amount from about 0.1% to about 5% by weight, and preferably, from about 0.1% to about 1% by weight. In the preferred embodiment, the amylase is an oxygen bleach resistant α-amylase enzyme, available commercially under the trade name Duramyl.

In the present invention, it has most surprisingly been found that contrary to the teachings of the art in this field of endeavor, even by excluding alkali metal sulfites, but by combining the aforementioned levels of boric acid and polyhydroxy compound such as propanediol with an oxygen bleach resistant α-amylase enzyme, a better enzyme stabilizing formulation results, which is very effective in stabilizing a Duramyl α-amylase enzyme, as compared to a Termamyl α-amylase enzyme. The compostion may optionally include other enzymes, including mixtures of proteases and amylases. But it has been demonstrated that a combination of Duramyl—oxygen bleach resistant α-amylase enzyme, 0.1% to 15% boric acid and 0.1% to 10% polyhydroxy compound, when added to other detergent ingredients, results in a detergent composition which exhibits high degree of Duramyl enzyme stability as compare to Termamyl enzyme stability. This is indeed a surprising discovery and claimed henceforth in this invention.

### Other Detergent Ingredients

(a) Thickeners

The physical stability of the liquid product may be improved and the thickness of the liquid product may be altered by the addition of a cross linking polyacrylate thickener to the liquid detergent product as a thixotropic thickener.

(b) PH Adjusting Components

The above liquid detergent product is preferably low foaming, readily soluble in the washing medium and most effective at pH values best conducive to improved cleaning performance, such as in a range of desirably from about pH 6.5 to about pH 12.5, and preferably from about pH 7.0 to about pH 12.0, more preferably from about pH 8.0 to about pH 12.0, and most preferably, less than about 9.0 pH The pH adjusting components are desirably selected from sodium or potassium hydroxide, sodium or potassium carbonate or sesquicarbonate, sodium or potassium silicate, boric acid, sodium or potassium bicarbonate, sodium or potassium borate, and mixtures thereof. NaOH or KOH are the preferred ingredients for increasing the pH to within the above ranges. Other preferred pH adjusting ingredients are sodium carbonate, potassium carbonate, and mixtures thereof.

(c) Low Foaming Surfactant

The liquid nonionic surfactant detergents that can be used to practice the present invention are preferably are alkyl ethoxylates in non-chlorine bleach liquid ADW compositions. One example of a non-chlorine bleach stable surfactant is SLF18® manufactured by BASF Corporation. Alternatively, in chlorine bleach containing liquid ADW compositions, chlorine bleach stable low foaming surfactants are preferred and such surfactants are present in a range of from about 0.1% to about 10% by weight of the liquid composition. Such surfactants are generally known to one skilled in the art and need not be elaborated here, for purposes of brevity. An example of a chlorine bleach stable surfactant is Dowfax® anionic surfactant available from the Dow Chemical Company.

(d) Enzymes

The preferred enzyme is Duramyl—an oxygen bleach resistant α-amylase enzyme. This enzyme is well described in the literature, WO 95/10603, which is incorporated herein by reference.

(e) Other Adjunct Detergent Ingredients

The liquid detergent composition may optionally contain up to about 20% of a dispersant polymer selected from the group consisting of polyacrylates and polyacrylate copolymers.

To exemplify an embodiment of the present invention and demonstrate its benefits, Formula B, an embodiment of the present invention having 3% boric acid, 0.5% propanediol and Duramyl, is compared with Formula A, having 3% boric acid, 0.5% propanediol and Termamyl, in Table 1. A comparison of the Duramyl amylase enzyme stability v.s Termamyl enzyme stability is shown in Table 2.

TABLE 1

| Ingredients (active) | Formula A | Formula B |
|---|---|---|
| STPP | 16 | 16 |
| K2SO4 | 16 | 16 |
| Boric Acid | 3.0 | 3.0 |
| 1,2 propanediol | 0.5 | 0.5 |
| CaCl2.2H2O | 0.037 | 0.037 |
| Non-ionic surfactant | 0.5 | 0.5 |
| Protease (4% active) | 0.5 | 0.5 |
| Termamyl (4% active) | 0.27 | — |
| Duramyl (4% active) | — | 0.27 |
| Polyacrylate thickener | 1.22 | 1.22 |
| Perfume | 0.10 | 0.10 |
| Dye | 0.0016 | 0.0016 |
| DI water | BAL | BAL |

TABLE 2

| % amylase remaining @ 80 F. | Formula A | Formula B |
|---|---|---|
| after 7 days | 63 | 89 |
| after 14 days | 36 | 77 |
| after 28 days | 34 | 76 |
| after 42 days | 29 | 72 |

Accordingly, having thus described the invention in detail, it will be obvious to those skilled in the art that various changes may be made without departing from the scope of the invention and the invention is not to be considered limited to what is described in the specification.

What is claimed is:

1. An aqueous liquid or gel type detergent composition, comprising:
(a) from about 0.1% to about 15% by weight, boric acid;
(b) from about 0.1% to about 10% by weight, a polyhydroxy compound selected from the group consisting of ethylene glycol, propylene glycol, 1,2-propanediol, butylene glycol, hexylene glycol, mannitol, sorbitol, erythritol, glucose fructose, lactose, erythritol-1,4-anhydride, and mixtures thereof;
(c) from about 0.1% to about 2% by weight, an oxygen bleach resistant α-amylase enzyme; and
(d) from about 5% to about 80% water.

2. The dishwashing detergent composition according to claim 1, including from about 0.5% to about 10% by weight boric acid.

3. The dishwashing detergent composition according to claim 2, including from about 1% to about 5% by weight boric acid.

4. The dishwashing detergent composition according to claim 1, wherein said polyhydroxy compound is 1,2-propanediol.

5. The dishwashing detergent composition according to claim 1, including from about 0.1% to about 5% by weight said polyhydroxy compound.

6. The dishwashing detergent composition according to claim 5, including from about 0.1% to about 1% by weight said polyhydroxy compound.

7. The dishwashing detergent composition according to claim 1, wherein said composition is free of alkalimetal sulphites.

8. A process for stabilizing an amylase enzyme in an aqueous enzymatic liquid detergent composition, comprising the steps of:
(a) providing an enzyme stabilizing combination comprising:
(i) from about 0.1% to about 15% by weight, boric acid;
(ii) from about 0.1% to about 10% by weight, a polyhydroxy compound selected from the group consisting of ethylene glycol, propylene glycol, 1,2-propanediol, butylene glycol, hexylene glycol, mannitol, sorbitol, erythritol, glucose fructose, lactose, erythritol-1,4-anhydride, and mixtures thereof;
(iii) an oxygen bleach resistant α-amylase enzyme; and
(b) mixing said enzyme stabilizing combination with liquid detergent ingredients.

9. The detergent composition according to claim 1 further comprising from 0.1% to 2% of a protease enzyme.

10. A process according to claim 7 comprising, by weight of the composition, from 1% to 5% of boric acid, from 0.1% to 7% of the polyhydroxy compound, and from 0.1% to 2% of the oxygen bleach resistant α-amylase enzyme.

11. A process according to claim 7 comprising from 40% to 70% water, and wherein the polyhydroxy compound is 1,2-propanediol.

12. A process according to claim 7 further comprising from 0.1% to 2% of a protease enzyme.
